(19) United States
(12) Patent Application Publication
(10) Pub. No.: US 2008/0304694 A1
(43) Pub. Date: Dec. 11, 2008

(54) Speaker

(75) Inventor: Shigeru Hayashi, Fukuroi-Shi (JP)

Correspondence Address: WENDEROTH, LIND & PONACK, L.L.P., 2033 K STREET N. W., SUITE 800, WASHINGTON, DC, 20006-1021, US

(73) Assignee: MINEBEA CO., LTD.

(21) Appl. No.: 12/149,668

(22) Filed: May 6, 2008

(30) Foreign Application Priority Data
Jun. 6, 2007 (JP) 2007-150612

(51) Int. Cl. H04R 1/00

(52) U.S. Cl. 381/397

(57) ABSTRACT

A speaker includes: a heat sink disposed at the front of a bobbin; and a coupler disposed between the front of the heat sink and the rear of a diaphragm, wherein the heat sink includes: a base portion having an outer circumferential wall and disposed inside the bobbin; and a flange portion extending axially outwardly from the forefront of the outer circumferential wall and having its rear face disposed in contact with the front of the bobbin, and the coupler includes: a diaphragm supporting portion disposed at the rear of the diaphragm; and inner and outer annular walls disposed at the diaphragm supporting portion, and wherein the heat sink is connected to the coupler such that the base portion and the flange portion of the heat sink are connected respectively to the inner annular wall and the outer annular wall of the coupler.

### BACKGROUND OF THE INVENTION

1. Field of the Invention

The present invention relates to a speaker for use in audio equipment, information and communication equipment, and the like.

2. Description of the Related Art

FIG. 15 shows a general conventional speaker. Referring to FIG. 15, a conventional speaker 100 includes: a magnetic circuit 105 which is basically composed of a ring magnet 101, a top plate 102 having a ring shape and disposed at the front of the magnet 102, a center pole 103 disposed through the center openings of the magnet 101 and the top plate 102, and a yoke 104 disposed at the rear of the magnet 102 and having the center pole 103 standing at its center; a bobbin 106 disposed to enclose a portion of the magnetic circuit 105; a voice coil 107 wound around the bobbin 106, disposed in the magnetic gap of the magnetic circuit 105 and adapted to move forward and backward; a basket 108 connected to the magnetic circuit 105; a diaphragm 110 supportedly connected to the basket 108 via a surround 109; a spider 111 having its inner circumference connected to the bobbin 106 and having its outer circumference supported at the middle part of the basket 108; and a dust cap 112 disposed at the front of the center of the diaphragm 110.

In the speaker 100 described above, when a speech current is applied to the voice coil 107, the diaphragm 110 is caused to vibrate thereby producing sound, and at the same time heat is generated in the voice coil 107. The heat generated in the voice coil 107 is conducted to the bobbin 106, the diaphragm 110 and the cap 112 and dissipated therefrom, but in case of a vibration with a large amplitude, the voice coil 107 undergoes thermal destruction due to limited heat dissipation capacity.

Recently, the performance of an amplifier to drive a speaker is enhanced, and the speaker is required to withstand a large input. Under such a circumstance, a voice coil has its heat resistance performance improved thus becoming capable of withstanding a large input.

However, since the voice coil has an enhanced heat resistance performance and allows a larger input, and when a large input is applied to the voice coil, a higher heat is generated in the voice coil and conducted to a bobbin and a diaphragm. Recently, more and more diaphragms are made of a resin material, such as polypropylene for the reason of decent appearance and high rigidity, and the heat conducted to the diaphragm causes the resin material of the diaphragm to be softened at an area close to the bobbin, whereby the speaker can possibly be damaged.

Speakers with an enhanced heat dissipation performance are disclosed in, for example, Japanese Patent Applications Laid-Open Nos. 2004-260547 and 2005-354296.

In the speaker disclosed in the aforementioned Japanese Patent Application Laid-Open No. 2004-260547, a dust cap made of a metal material is attached to a voice coil to thereby efficiently dissipate heat from the dust cap.

In the speaker disclosed in the aforementioned Japanese Patent Application Laid-Open No. 2005-354296, a bobbin is provided with airflow vents, a cylindrical airflow control member having airflow openings is fixedly attached to the forefront of a pole piece so as to be disposed inside the bobbin in a coaxial manner, and when a vibrating system vibrates forward and backward, the pressure behind a spider is caused to change which provides positive and negative pressures alternately, whereby a two way airflow is generated between the space inside the bobbin or a magnetic circuit and the space behind the spider through the airflow vents and the airflow openings, and thus the bobbin and a voice coil wound around the bobbin can be cooled.

While the two speakers described above are structured to efficiently dissipate heat generated in the voice coil, the diaphragm is directly connected to the bobbin, and there is still a problem that heat is easily transferred to the diaphragm, and the diaphragm becomes softened.

### SUMMARY OF THE INVENTION

The present invention has been made in light of the problem described above, and it is an object of the present invention to provide a speaker in which heat generated in a voice coil is suppressed from conducting to a diaphragm thereby allowing a large input while having a simple structure without sacrifice to its appearance and sound quality.

According to an aspect of the present invention, there is provided a speaker which includes: a magnetic circuit including a magnet, a top plate disposed at a front of the magnet, and a yoke disposed at a rear of the magnet; a bobbin disposed to enclose a part of the magnetic circuit; a voice coil wound around the bobbin and disposed in a magnetic gap of the magnetic circuit so as to movable forward and backward; a basket connected to the magnetic circuit; a diaphragm having its outer circumference supportedly connected to the basket via a surround; and a spider having its inner circumference connected to the bobbin and having its outer circumference supportedly connected to a middle portion of the basket, wherein the speaker further includes a heat sink disposed at a front of the bobbin, and a coupler disposed between a front of the heat sink and a rear of the diaphragm.

In the speaker according to the present invention, heat generated in the voice coil is suppressed from conducting to the diaphragm thereby allowing a large input while having a simple structure without sacrifice to its appearance and sound quality.

### BRIEF DESCRIPTION OF THE DRAWINGS

FIG. 1 is a cross sectional view of a speaker according to a first embodiment of the present invention;

FIG. 2 is a cross sectional view of a heat sink and a coupler of the speaker of FIG. 1;

FIG. 3A is a cross sectional view of a speaker according to a second embodiment of the present invention;

FIG. 3B is a top plan view of a heat sink of the speaker of FIG. 3A;

FIG. 4A is a cross sectional view of a speaker according to a third embodiment of the present invention;

FIG. 4B is a top plan view of a heat sink of the speaker of FIG. 4A;

FIG. 5A is a cross sectional view of a speaker according to a fourth embodiment of the present invention;

FIG. 5B is a bottom plan view of a coupler of the speaker of FIG. 5A;

FIG. 5C is an enlarged bottom perspective view of the coupler of FIG. 5B;

FIG. 6 is a cross sectional view of a speaker according to a fifth embodiment of the present invention;

FIG. 7A is a cross sectional view of a speaker modified from the speaker of FIG. 6;

FIG. 7B is a perspective view of a bobbin of the speaker of FIG. 7A;

FIG. 8 is a cross sectional view of a speaker according to a sixth embodiment of the present invention;

FIG. 9 is a cross sectional view of a speaker according to a seventh embodiment of the present invention;

FIG. 10 is a cross sectional view of a speaker modified from the speaker of FIG. 9;

FIG. 11 is a cross sectional view of a speaker according to an eighth embodiment of the present invention;

FIG. 12 is a cross sectional view of a speaker with an inner magnetic circuit as an example of the present invention;

FIGS. 13A to 13C are cross sectional views of modified couplers;

FIGS. 14A and 14B are cross sectional views of further modified couplers and also modified connection modes with respective heat sinks; and

FIG. 15 is a cross sectional view of a conventional speaker.

### DETAILED DESCRIPTION OF THE INVENTION

Exemplary embodiments of the present invention will hereinafter be described with reference to the accompanying drawings.

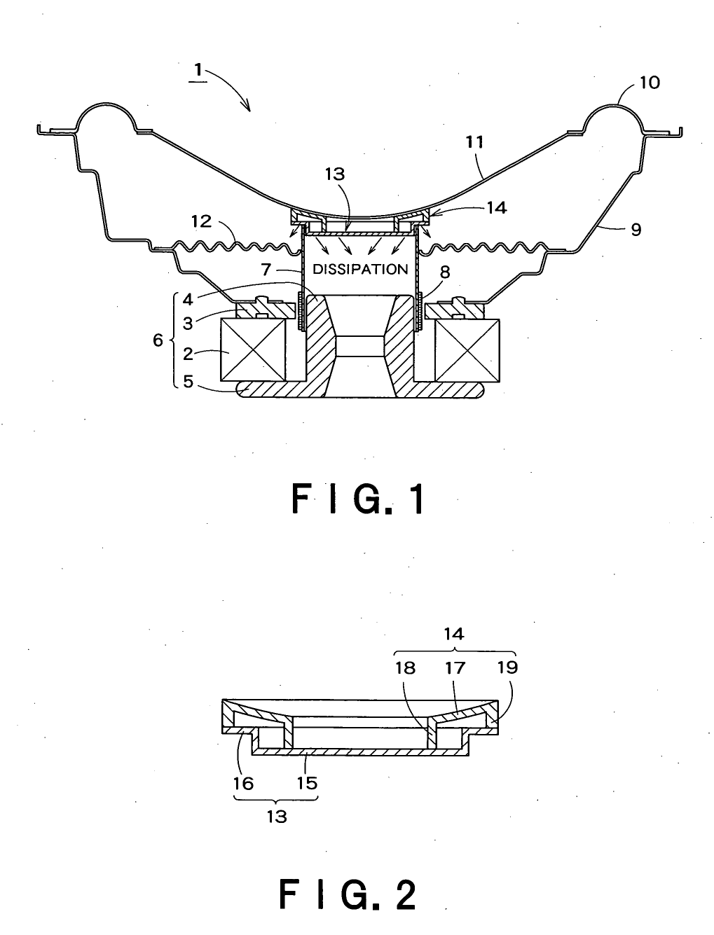

A first embodiment of the present invention will be described with reference to FIGS. 1 and 2. Referring to FIG. 1, a speaker 1 according to the first embodiment includes: an outer magnetic circuit 6 composed of a ring magnet 2, a top plate 3 having an annular shape and disposed at the front of the magnet 2, a center pole 4 disposed through the magnet 2, and a yoke 5 having the center pole 4 standing at its center; a bobbin 7 to enclose a part of the magnetic circuit 6; a voice coil 8 wound around the bobbin 7, disposed in the magnetic gap of the magnetic circuit 6 and adapted to move forward and backward; a basket 9 connected to the magnetic circuit 6; a diaphragm 11 having its outer circumference connected to the basket 9 via a surround 10; a spider 12 having its inner circumference connected to the bobbin 7 and having its outer circumference supported at the middle portion of the basket 9; a heat sink 13 disposed at the front of the bobbin 7; and a coupler 14 disposed between the front of the heat sink 13 and the rear of the diaphragm 11.

The bobbin 7 is made of, for example, aluminum, and the diaphragm 11 is made of a resin material, for example, polypropylene. A throughhole for airflow is provided at the center of the center pole 4. The heat sink 13 is made of a highly heat conductive material, specifically a metal material such as aluminum, iron and zinc alloy. The coupler 14 is made of a material having a lower heat conductivity than that of the heat sink 13a, for example a resin material or a metal material, and a resin material, specifically an ABS resin is employed in the present embodiment.

Referring to FIG. 2, the heat sink 13 includes a base portion 15 shaped in a disk with a circumferential wall, and a flange portion 16 extending radially outwardly from the forefront of the circumferential wall of the base portion 15 and having its rear face disposed in contact with the front of the bobbin 7. The coupler 14 includes a diaphragm supporting portion 17 shaped in an annular disk and disposed behind the diaphragm 11, an inner circular wall 18 disposed at the inner circumference of the diaphragm supporting portion 17, and an outer circular wall 19 disposed at the outer circumference of the diaphragm supporting portion 17. The inner circular wall 18 of the coupler 14 is connected to the base portion 15 of the heat sink 13, and the outer circular wall 19 of the coupler 14 is connected to the outer circumference of the flange portion 16.

In the speaker 1 described above, when a large input is applied to the voice coil 8, a high heat is generated in the voice coil 8 and transferred to the heat sink 13 via the bobbin 7, whereby the heat is dissipated efficiently from the surface of the heat sink 13. Air heated by the heat dissipated from the heat sink 13 partly passes through the airflow hole of the center pole 4 and the yoke 5 to go behind the speaker 1 and partly goes into the space enclosed by the diaphragm 11, the spider 12 and the basket 9, whereby the heat generated in the voice coil 8 and transferred to the heat sink 13 is efficiently dissipated.

The coupler 14 disposed between the heat sink 13 and the diaphragm 11 is made of a material with a low heat conductivity and therefore the heat transferred to the heat sink 13 is hard to be further transferred to the diaphragm 11, thus preventing the problem that the diaphragm 11 becomes softened by the heat generated in the voice coil 8.

Thus, in the speaker 1 according to the first embodiment, the heat sink 13 and the coupler 14 are disposed between the bobbin 7 and the diaphragm 11, and the heat generated in the voice coil 8 is dissipated efficiently via the heat sink 13. As a result, the speaker 1 has a simple structure and at the same time can withstand a large input by suppressing the heat generated in the voice coil 8 from conducting to the diaphragm 11 wherein its appearance and sound quality are not impaired.

Also, the coupler 14 facilitates the process of bridging between the diaphragm 11 and the heat sink 13. If the diaphragm 11 is to be attached directly to the heat sink 13 without the coupler 14, it is difficult to position the diaphragm 11, thus raising a workability problem. Since the coupler 14 in the present embodiment is previously provided with the diaphragm supporting portion 17 for receiving the diaphragm 11 and the inner and outer circular walls 18 and 19 for connection to the heat sink 13, the positioning between the heat sink 13 and the diaphragm 11 can be performed easily and precisely.

There is a hollow space between the heat sink 13 and the coupler 14, which contributes to weight reduction. The heat sink 13 and the coupler 14, together with the diaphragm 11, make up a vibrating system, and if the weight of the vibrating system increases, the driving efficiency is lowered and the acoustic characteristic is deteriorated. Such deterioration can be avoided thanks to the hollow structure described above. In this connection, if the heat sink 13 and the coupler 14 are made of a lightweight material, then the hollow space structure may not be essential. Also, when the hollow space is not provided, an airflow vent may be provided as described later.

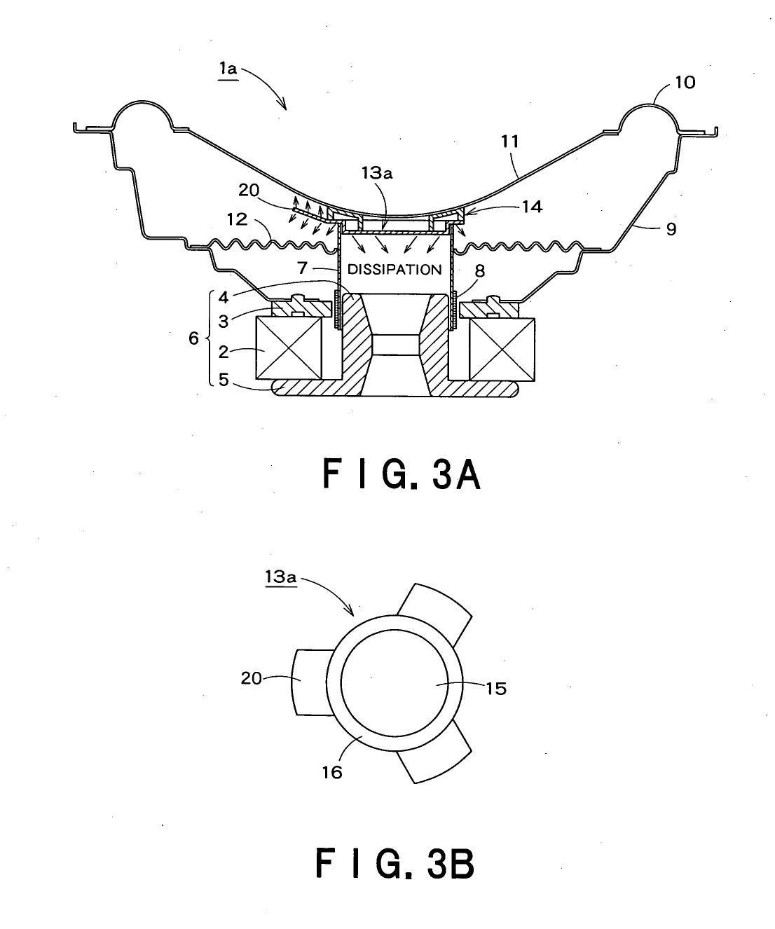

A second embodiment of the present invention will be described with reference to FIGS. 3A and 3B. A speaker 1a according to the second embodiment differs from the speaker 1 of the first embodiment only in heat sink structure, and description will be focused on the difference wherein any component parts corresponding to those in FIGS. 1 an 2 are denoted by the same reference numerals, and a detailed description thereof will be omitted below.

Referring to FIGS. 3A and 3B, a heat sink 13a of the speaker 1a includes, in addition to a base portion 15 and a flange portion 16, a plurality (three in FIG. 3B) of fins 20 each having a substantially rectangular shape and extending radially outwardly from the outer circumference of the flange portion 16. Otherwise, the speaker 1a according to the second embodiment is the same as the speaker 1 according to the first embodiment.

Since the heat sink 13a has a larger surface area than the heat sink 13 by the aggregate surface area of the fins 20, the heat generated in the voice coil 8 and transferred to the heat sink 13a can be dissipated more efficiently, whereby the speaker 1a can withstand a larger input than the speaker 1 according to the first embodiment.

The shape and the number of the fins 20 are not limited to those of the embodiment described above and may be modified within the spirit of the present invention.

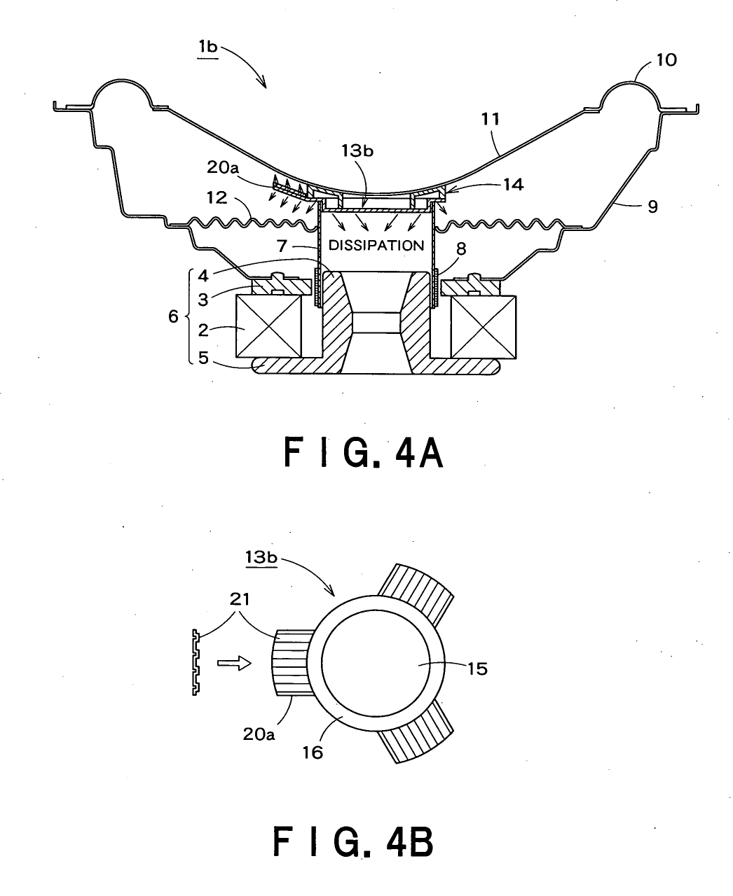

A third embodiment of the present invention will be described with reference to FIGS. 4A and 4B. A speaker 1b according to the third embodiment is similar to the speaker 1a of the second embodiment but differs therefrom in fin structure for a heat sink, and description will be focused on the difference wherein any component parts corresponding to those in FIGS. 3A and 3B are denoted by the same reference numerals, and a detailed description thereof will be omitted below.

Referring to FIGS. 4A and 4B, a heat sink 13b of the speaker 1b includes a base portion 15, a flange portion 16, and a plurality (three in FIG. 4B) of fins 20a which each have a substantially rectangular shape, extend radially outwardly from the outer circumference of the flange portion 16, and which have a wave-shaped surface 21 thereby increasing its surface area. Otherwise, the speaker 1b according to the second embodiment has the same structure as the speaker 1a according to the second embodiment in which the fins 20 of the heat sink 13 have a plain surface.

Since the surface area of the fins 20a is increased due to the wave-shaped surface 21, the heat generated in a voice coil 8 and transferred to the heat sink 13b can be efficiently dissipated from the fins 20a in the air. Accordingly, the speaker 1b can withstand a larger input than the speaker 1a according to the second embodiment.

The shape and the number of the fins 20a are not limited to those of the embodiment described above and may be modified within the spirit of the present invention.

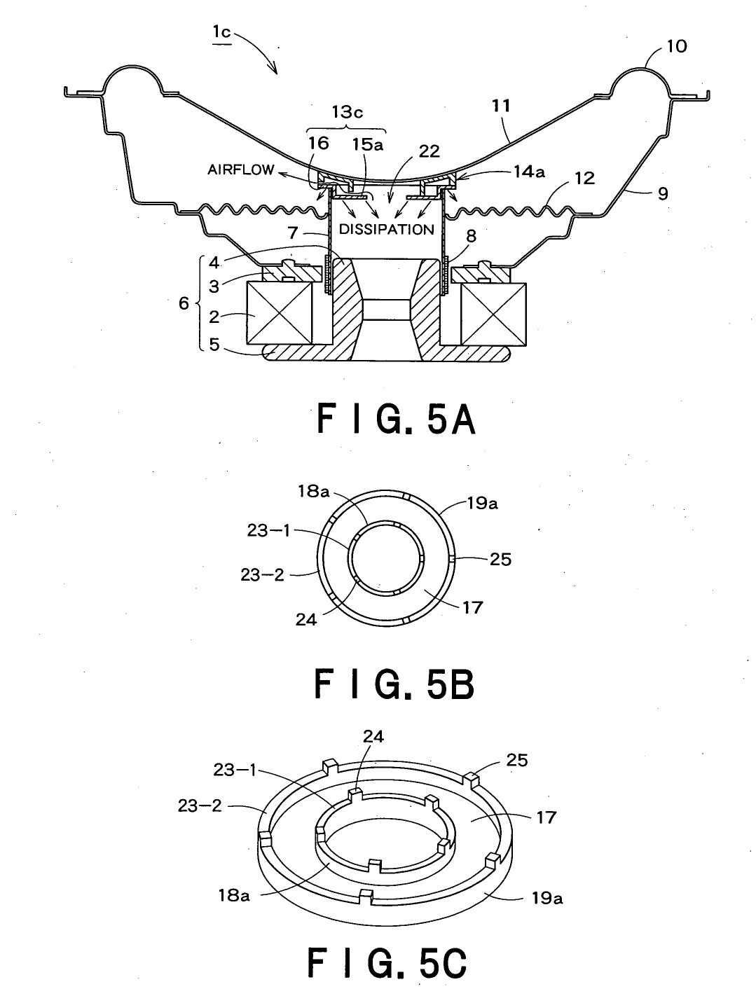

A fourth embodiment of the present invention will be described with reference to FIGS. 5A, 5B and 5C. A speaker 1c according to the fourth embodiment is similar to the speaker 1 according to the first embodiment but differs therefrom in heat sink structure and coupler structure, and description will be focused on the difference wherein any component parts corresponding to those in FIGS. 1 and 2 are denoted by the same reference numerals, and a detailed description thereof will be omitted below.

Referring to FIG. 5A, a heat sink 13c of the speaker 1c has an opening 22 with a circular shape as an airflow vent at the center of a base portion 15a. Referring to FIGS. 5B and 5C, an inner circular wall 18a of a coupler 14a of the speaker 1c has at least one (five in the figures) protrusion 24, and when the coupler 14a is connected to the heat sink 13c with the protrusion 24 disposed in contact with the base portion 15a, at least one (five in the figures) void space 23-1 is formed which functions as an airflow vent. An outer circular wall 19a of the coupler 14a has at least one (five in the figures) protrusion 25, and when the coupler 14a is connected to the heat sink 13c with the protrusion 25 disposed in contact with the flange portion 16, at least one (five in the figures) void space 23-2 is formed which functions as an airflow vent. Otherwise, the speaker 1c according to the fourth embodiment has the same structure as the speaker 1 according to the first embodiment

In the speaker 1c of the fourth embodiment, the hollow space formed between the heat sink 13c and the coupler 14a is adapted to communicate with the space enclosed by a diaphragm 11, a spider 12 and a basket 9 via the void spaces 23-1 and 23-2 thereby causing airflow therebetween, and is also adapted to communicate, via the circular opening 22, with the space inside a bobbin 7 and eventually the open air behind a yoke 5. Since the air inside the space formed between the heat sink 13c and the coupler 14a, which is heated by the heat generated in a voice coil 8 and transferred to the heat sink 13c, can be efficiently cooled, the speaker 1c is excellent in heat dissipation performance and therefore capable of withstanding a large input.

The shape and the number of the protrusions 24 and 25 are not limited to those of the embodiment described above and may be modified within the spirit of the present invention. Also, the base portion 15a of the heat sink 13c has one circular-shaped opening 22 at its center in the embodiment but the present invention is not limited to such an arrangement, and the shape and the number of openings may be varied as appropriate.

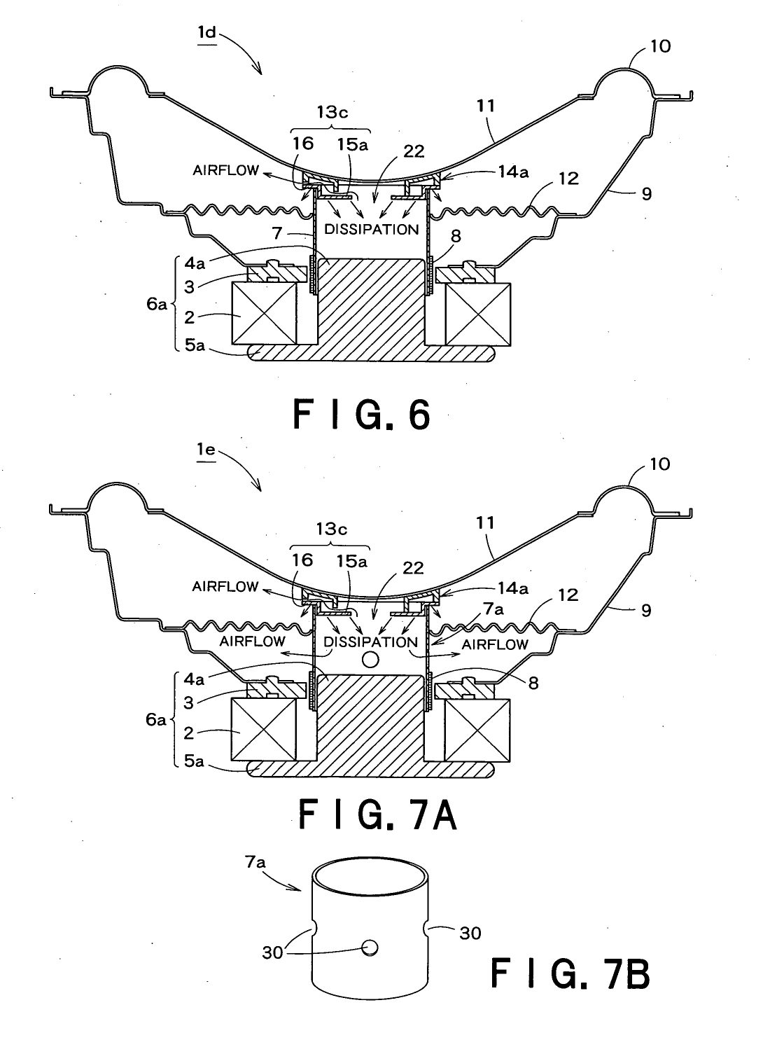

A fifth embodiment of the present invention will be described with reference to FIGS. 6, 7A and 7B. A speaker 1d according to the fifth embodiment differs in magnetic circuit structure from the speaker 1c of the fourth embodiment, and description will be focused on the difference wherein any component parts corresponding to those in FIGS. 5A and 5B are denoted by the same reference numerals, and a detailed description thereof will be omitted below.

Referring to FIG. 6, a magnetic circuit 6a of the speaker 1d is different from the magnetic circuit of the speaker 1c of the fourth embodiment in that a yoke 5a and a center pole 4a disposed to stand at the center of the yoke 5a have no throughhole as an airflow vent. Otherwise, the speaker 1d has the same structure as the speaker 1c of the fourth embodiment.

Since the magnetic circuit 6a of the speaker 1d has no throughhole at the yoke 5a and the center pole 4a, the heated air near a heat sink 13c does not flow toward the center pole 4a but is caused to flow into the space enclosed by a diaphragm 11, a spider 12 and a basket 9 at a faster speed via a circular opening 22 and void spaces 23-1 and 23-2 (refer to FIGS. 5B and 5C), whereby the air inside a bobbin 7 can be efficiently cooled.

In the speaker 1d of FIG. 6, the air near the heat sink 13c does not flow toward the center pole 4a, and it may possibly happen that the temperature of the air inside the space enclosed by the diaphragm 11, the spider 12 and the basket 9 goes up. So, the bobbin 7 may be provided with a hole as an airflow vent. A speaker 1e shown in FIG. 7A is a modification of the fifth embodiment and includes, as shown in FIG. 7B, a bobbin 7a which has at least one (four in the figure) airflow vent 30. Otherwise, the speaker 1e has the same structure as the speaker 1d.

In the speaker 1e of FIG. 7A, the heated air around the heat sink 13c is caused to flow out through the airflow vents 30 as well as into the space enclosed by the diaphragm 11, the spider 12 and the basket 9, whereby it is prevented from happening that the temperature of the air inside the space enclosed by the diaphragm 11, the spider 12 and the basket 9 goes up to an abnormally high temperature.

The shape and the number of the airflow vent 30 are not limited to those of the embodiment described above and may be modified within the spirit of the present invention.

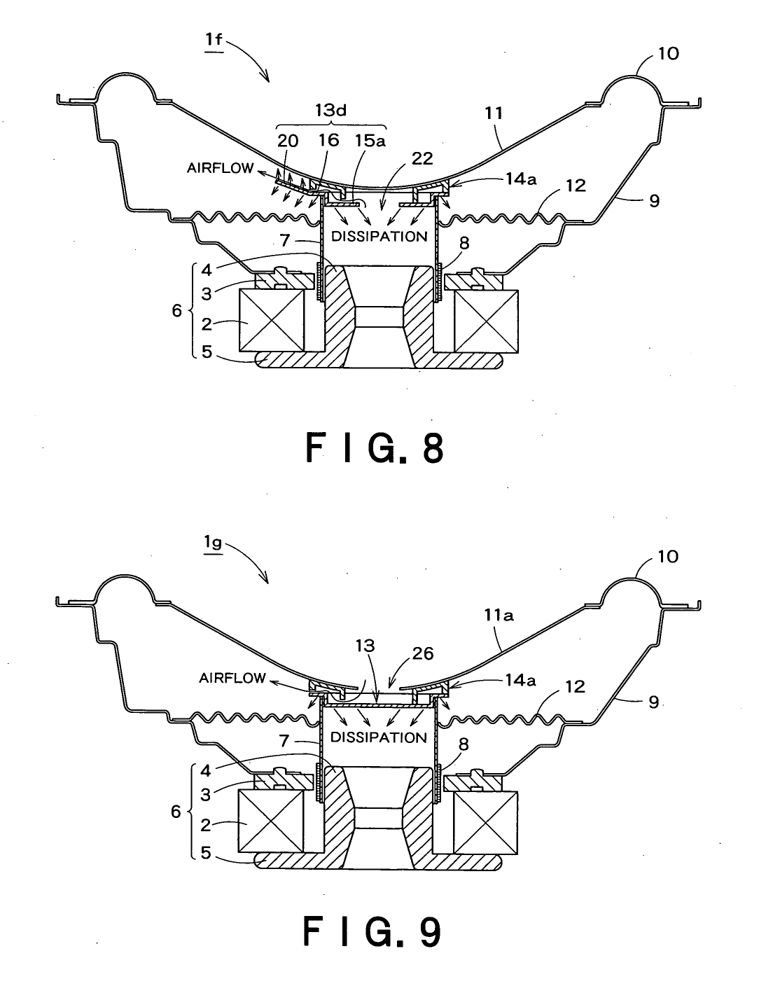

A sixth embodiment of the present invention will be described with reference to FIG. 8. A speaker 1f according to the sixth embodiment differs in heat sink structure from the speaker 1c according to the fourth embodiment, and description will be focused on the difference wherein any component parts corresponding to those in FIGS. 5A and 5B are denoted by the same reference numerals, and a detailed description thereof will be omitted below.

Referring to FIG. 8, a heat sink 13d of the speaker 1f includes fins 20 like the speaker 1a according to the second embodiment. Otherwise, the speaker 1f has the same structure as the speaker 1c according to the fourth embodiment.

In the speaker 1f according to the sixth embodiment, heat generated in a voice coil 8 and transferred to the heat sink 13d via a bobbin 8 can be efficiently dissipated from the fins 20. Accordingly, the speaker 1f according to the sixth embodiment can withstand a larger input than the speaker 1c according to the fourth embodiment.

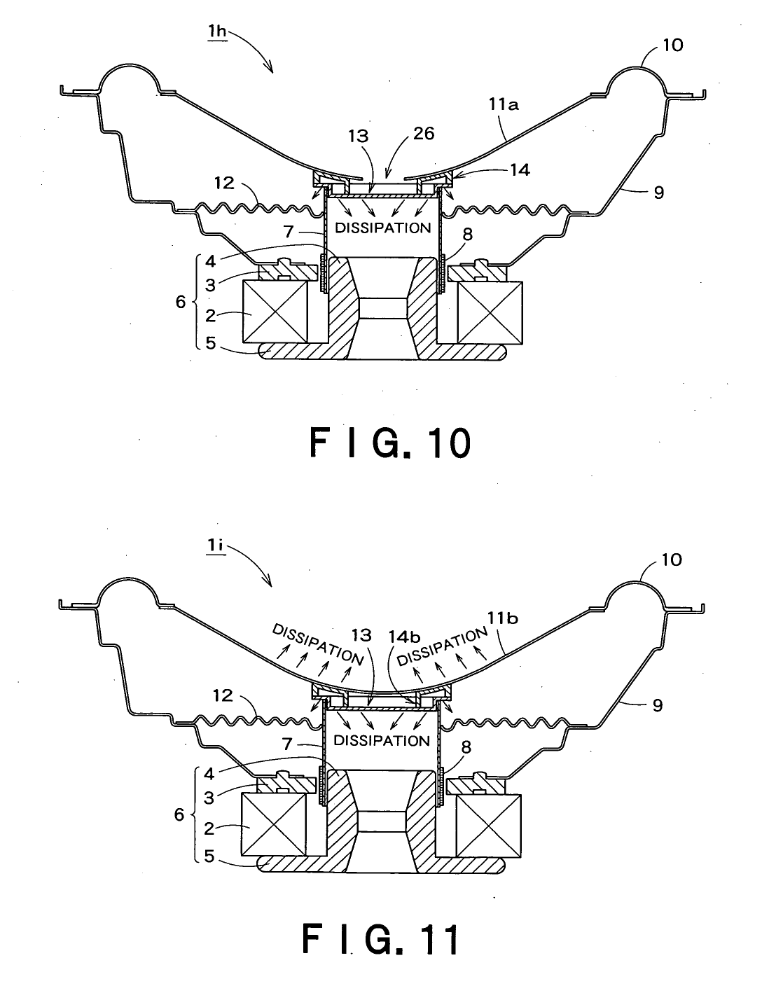

A seventh embodiment of the present invention will be described with reference to FIGS. 9 and 10. A speaker 1g according to the seventh embodiment differs in coupler structure and diaphragm structure from the speaker 1 of FIG. 1 according to the first embodiment, and description will be focused on the difference wherein any component parts corresponding to those in FIG. 1 are denoted by the same reference numerals, and a detailed description thereof will be omitted below.

Referring to FIG. 9, a coupler 14a of the speaker 1g is structured the same as that of the speaker 1c according to the fourth embodiment and thus includes a plurality of void spaces 23-1 and 23-2 (refer to FIGS. 5B and 5C), and a diaphragm 11a of the speaker 1g has a center opening 26 (shaped, for example, circular) as an airflow vent. Otherwise, the speaker 1g has the same structure as the speaker 1 according to the first embodiment.

In the speaker 1g according to the seventh embodiment, through the center opening 26 of the diaphragm 11a and the void spaces 23-1 and 23-2 of the coupler 14a, the space enclosed by the diaphragm 11a, a spider 12 and a basket 9 communicates with the space in front of the diaphragm 11a, thus allowing an airflow between both the spaces when the diaphragm 11a vibrates.

Consequently, a heat sink 13 heated by heat generated in a voice coil 8 can be efficiently cooled, and the speaker 1g according to the seventh embodiment can withstand a large input.

In the embodiment described above, the center opening 26 of the diaphragm 11a is constituted by one circular hole, but the present invention is not limited to such an arrangement and a plurality of holes shaped other than circular may be possible as appropriate.

In the speaker 1g of FIG. 9 described above, the sound quality may potentially be affected by the air which is moved to the front of the diaphragm 11a from the space enclosed by the diaphragm 11a, the spider 12 and the basket 9.

If the above is the case, the void spaces 23-1 and 23-2 of the coupler 14a may be eliminated thus constituting a coupler identical to the coupler 14 of the speaker 1 of FIG. 1 according to the first embodiment. Shown in FIG. 10 is a speaker 1h as an exemplary modification of the speaker 1g according to the present embodiment. With the modification described above, the speaker 1h of FIG. 10 is different from the speaker 1 according to the first embodiment only in diaphragm structure, specifically that a diaphragm 11a of the speaker 1h has a center opening 26.

In the speaker 1h of FIG. 10, since the air in the space enclosed by the diaphragm 11a, the spider 12 and the basket 9 is prevented from moving to the inside of a heat sink 13, and therefore to the front of the diaphragm 11a due to the coupler 14 not having void spaces 23-1 and 23-2 as airflow vents, the presence of the center opening 26 of the diaphragm 11a hardly affects the acoustic characteristic.

An eighth embodiment of the present invention will be described with reference to FIG. 11. A speaker 1i according to the eighth embodiment is different in diaphragm material and coupler material from the speaker 1 of FIG. 1 according to the first embodiment, and description will be focused on the difference wherein any component parts corresponding to those in FIG. 1 are denoted by the same reference numerals, and a detailed description thereof will be omitted below.

In the speaker 1i of FIG. 11, a diaphragm 11b and a coupler 14b are made of a metal material with a high heat conductivity, such as aluminum, iron, zinc alloy, and the like, instead of a resin material of which the diaphragm 11 and the coupler 14 of the speaker 1 according to the first embodiment are made. In terms of configuration, the speaker 1h is the same as the speaker 1 according to the first embodiment.

In the speaker 1i according to the eighth embodiment, heat generated in a voice coil 8 and conducted via a bobbin 7 to a heat sink 13 can be efficiently dissipated from the surface of the diaphragm 11b and the coupler 14b as well as the heat sink 13. Accordingly, the speaker 1i is enabled to withstand a large input.

The coupler 14b and the heat sink 13 of the speaker 1i may be made of the same or different material. In the case of using the same material, the coupler 14b and the heat sink 13 may be formed into one integral member. Such the integral member is disposed with its front connected to the rear of the diaphragm 11b and with its rear connected to the front of the bobbin 7. With such integration, the process of putting together the coupler 14b and the heat sink 13 is eliminated, and the workability and productivity are enhanced.

While the present invention has been explained with respect to the exemplary embodiments thereof, the present invention is not limited thereto, and many variations and modifications may be possible without departing from the spirit of the present invention.

For example, the features of any of the first to eighth embodiments may be combined with each other or one another.

Also, the speakers 1 to 1i according to the first to eighth embodiments include an outer magnetic circuit 6/6a but the magnetic circuit 6/6a can be substituted by an inner circuit.

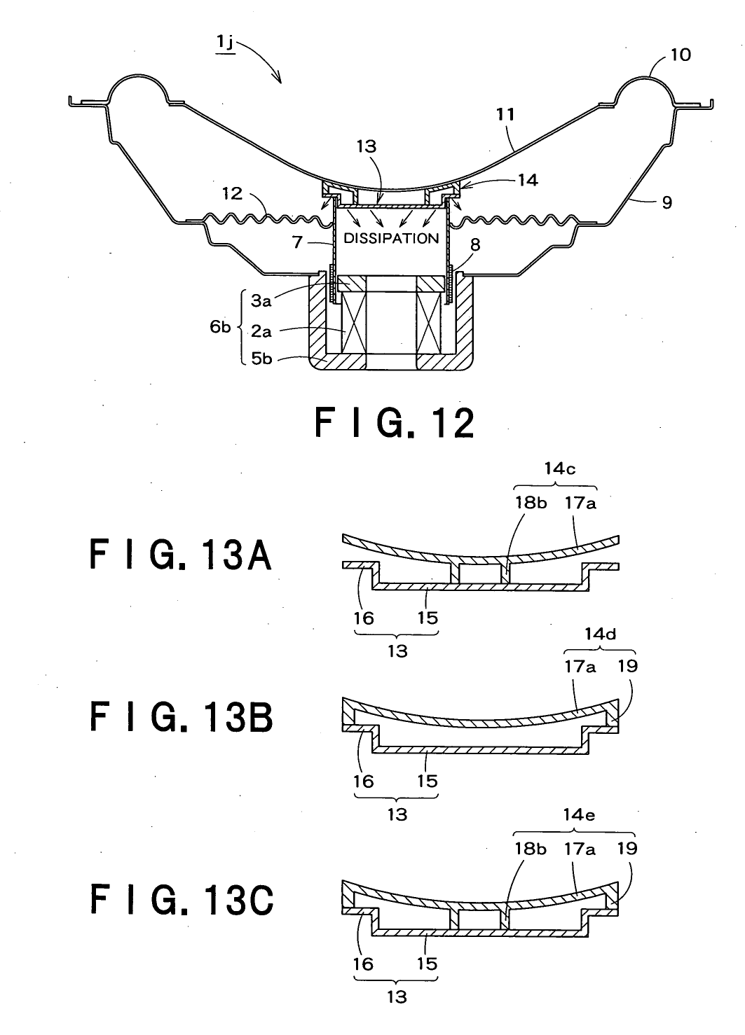

Referring to FIG. 12, a speaker 1j includes an inner magnetic circuit 6b to substitute the outer magnetic circuit 6 of the speaker 1 according to the first embodiment. The magnetic circuit 6b includes a circular cylindrical magnet 2a, an annular top plate 3a disposed at the front of the magnet 2a, and a yoke 5b disposed at the rear of the magnet 2a.

Further, the present invention is not limited to the exemplary embodiments in coupler structure, heat sink structure, and connection mode between a coupler and a heat sink, and many variations may be applied, for example, as follows.

Referring to FIG. 13A, a coupler 14c may be proposed which is composed of a disk-like diaphragm supporting portion 17a and a circular wall 18b disposed at the center portion of the diaphragm supporting portion 17a, wherein the circular wall 18b is connected to a base portion 15 of a heat sink 13. In this structure, a circular wall is not needed at the outer circumference of the diaphragm supporting portion 17a.

Referring to FIG. 13B, a coupler 14d may be possible which is composed of a diaphragm supporting portion 17a and a circular wall 19 disposed at the outer circumference of the diaphragm supporting portion 17a, wherein the circular wall 19 is connected to a flange portion 16 of a heat sink 13. In this structure, a circular wall is not need at the center portion of the diaphragm supporting portion 17a.

Referring to FIG. 13C, a coupler 14e may be possible which is composed of a diaphragm supporting portion 17a, a circular wall 18b disposed at the center portion of the diaphragm supporting portion 17a, and a circular wall 19 disposed at the outer circumference of the diaphragm supporting portion 17a, wherein the circular walls 18b and 19 are connected respectively to a base portion 15 and a flange portion 16 of a heat sink 13.

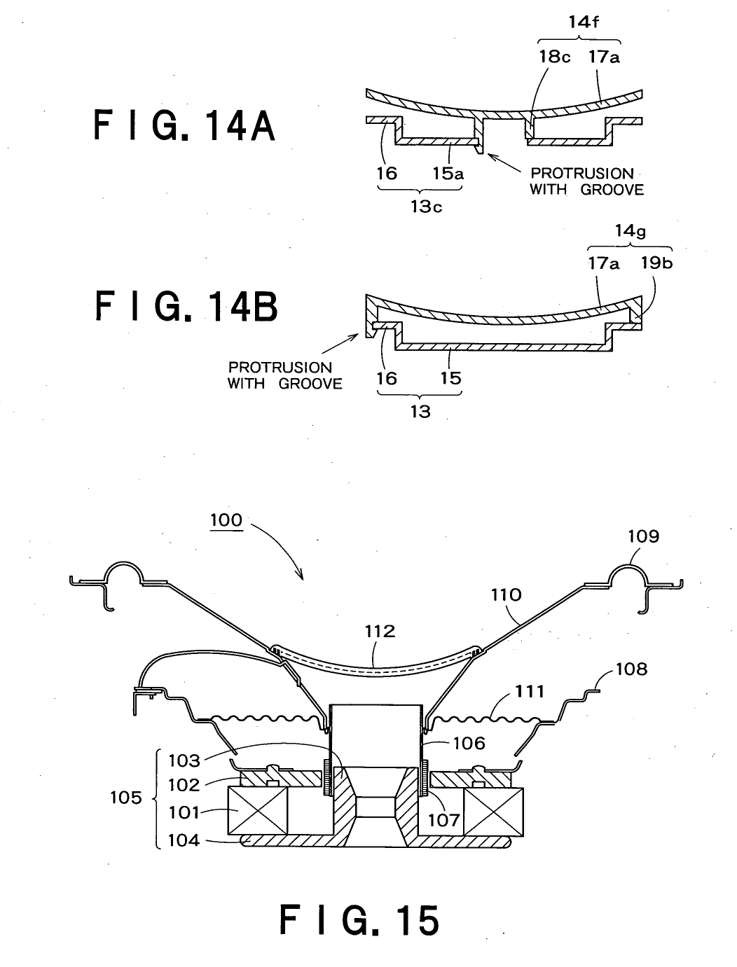

Now, referring to FIG. 14A, there may be proposed a coupler 14f composed of a diaphragm supporting portion 17a and a circular wall 18c which is disposed at the center portion of the diaphragm supporting portion 17a and which has at least one protrusion with a groove, while a heat sink 13c includes a base portion 15a having a center opening and a flange portion 16, wherein the coupler 14f is connected to the heat sink 13c such that the groove of the protrusion of the circular wall 18c engages with a portion of the inner circumference of the base portion 15a.

Also, a coupler 14g shown in FIG. 14B may be composed of a diaphragm supporting portion 17a, and a circular wall 19b disposed at the outer circumference of the diaphragm supporting portion 17a and having at least one protrusion with a groove, wherein the coupler 14g is connected to a heat sink 13 including a base portion 15 and a flange portion 16, such that the groove of the protrusion of the circular wall 19b engages with a portion of the outer circumference of the flange portion 16.

What is claimed is:

1. A speaker comprising:
a magnetic circuit comprising a magnet, a top plate disposed at a front of the magnet, and a yoke disposed at a rear of the magnet;
a bobbin disposed to enclose a part of the magnetic circuit;
a voice coil wound around the bobbin and disposed in a magnetic gap of the magnetic circuit so as to movable forward and backward;
a basket connected to the magnetic circuit;
a diaphragm having its outer circumference supportedly connected to the basket via a surround;
a spider having its inner circumference connected to the bobbin and having its outer circumference supportedly connected to a middle portion of the basket;
a heat sink disposed at a front of the bobbin; and
a coupler disposed between a front of the heat sink and a rear of the diaphragm.

2. A speaker according to claim 1, wherein the heat sink and the coupler are disposed to form a space therebetween.

3. A speaker according to claim 2, wherein the space is enclosed.

4. A speaker according to claim 2, wherein the space is provided with at least one airflow vent.

5. A speaker according to claim 1, wherein the heat sink comprises: a base portion having an outer circumferential wall and disposed inside the bobbin; and a flange portion extending axially outwardly from a forefront of the outer circumferential wall and having its rear face disposed in contact with the front of the bobbin, and the coupler comprises: a diaphragm supporting portion disposed at the rear of the diaphragm; and at least one of a first annular wall disposed at an inner circumference portion of the diaphragm supporting portion and a second annular wall disposed at an outer circumference of the diaphragm supporting portion, and wherein the heat sink is connected to the coupler at least one of: such that the base portion of the heat sink is connected to the first annular wall of the coupler; and such that the flange portion of the heat sink is connected to the second annular wall of the coupler.

6. A speaker according to claim 5, wherein at least one airflow vent is provided at the base portion, and wherein at least one void space as an airflow vent is provided at each of the first annular wall and the second annular wall.

7. A speaker according to claim 5, wherein the heat sink further comprises at least one fin extending axially outwardly from an outer circumference of the flange portion.

8. A speaker according to claim 7, wherein the at least one fin has a wave-shaped surface.

9. A speaker according to claim 1, wherein the diaphragm has an airflow vent at its center.

10. A speaker according to claim 9, wherein at leas one airflow vent is provided at the bobbin.

11. A speaker according to claim 1, wherein the coupler is made of a material which has a lower heat conductivity than a material of the heat sink.

12. A speaker according to claim 1 wherein at least one of the coupler and the diaphragm is made of a metal material containing at least one of aluminum, titan, magnesium alloy and beryllium alloy.

13. A speaker according to claim 1, wherein the magnetic circuit is of outer type and comprises a center pole standing at a center of the yoke, and a throughhole as an airflow vent is provided at a center of the center pole.

14. A speaker according to claim 1, wherein the magnetic circuit is of inner type and a throughhole as an airflow vent is provided at a center of each of the top plate, the magnet and the yoke.

15. A speaker according to claim 1, wherein the heat sink and the coupler are integrated with each other and made of a metal material, and the diaphragm is made of a metal material.
